(19) United States
(12) Patent Application Publication
(10) Pub. No.: US 2003/0095793 A1
(43) Pub. Date: May 22, 2003

(54) System and method for automatically refreshing data

(76) Inventors: James Alan Strothmann, Zionsville, IN (US); Michael Dillon Rich, Fishers, IN (US)

Correspondence Address: JOSEPH S. TRIPOLI, THOMSON MULTIMEDIA LICENSING INC., 2 INDEPENDENCE WAY, P. O. BOX 5312, PRINCETON, NJ, 08543-5312, US

(21) Appl. No.: 09/990,657

(22) Filed: Nov. 21, 2001

(51) Int. Cl. H04N 5/781

(52) U.S. Cl. 386/95; 386/124; 386/125

(57) ABSTRACT

The present invention concerns a method (200) and a system (100) for automatically refreshing previously recorded data on a recordable storage medium during playback of the previously recorded data from the recordable storage medium. The method includes the steps of: reading (212) a segment of the previously recorded data from the recordable storage medium; and re-writing (218) at least a portion of the segment of the previously recorded data back onto the recordable storage medium. In addition, the method can include the step of selectively examining (214) the segment of the previously recorded data by searching for errors in the previously recorded data in which the re-writing step can be performed only if the level of errors in the previously recorded data reaches a predetermined level.

### BACKGROUND OF THE INVENTION

1. Technical Field

The inventive arrangements relate generally to video recording systems and more particularly to video recording systems that record digitally encoded video sequences onto disc media such as recordable digital video discs, hard drives and optical discs.

2. Description of Related Art

Currently, many individuals use optical storage media technology to record television programs or important personal events such as weddings or graduations. Notably, however, several present optical storage media technologies such as DVD's or CD's have a limited retention period. That is, these optical storage media technologies begin to lose portions of the digital information (bits) that have been recorded onto the storage media over a period of time. For example, approximately five years after data has been recorded onto a DVD, the recorded data will begin to lose bits. Notably, the chemical reaction that produces phase-change characteristics in lightwaves, which is used for purposes of recording data onto optical media, loses its stability over a period of time. Moreover, exposing an optical storage medium to varying temperatures and/or excessive amounts of ambient light can further degrade the data stored on such a medium. Although error correction techniques in many optical storage media systems may salvage the information for purposes of playback, eventually the loss of bits will exceed the error correction capability and cause the picture quality of the recorded data to be severely degraded.

In light of the relatively short data retention period of certain optical storage media and the limitations of error correction, a user may have to re-record the data stored on the storage media from its original source approximately every five years. Such a procedure is tedious and a waste of time, particularly if a user has collected numerous media pieces for storage. Thus, a need exists for a method of automatically preserving data that has been recorded onto storage media without requiring a user to re-record the data.

### SUMMARY OF THE INVENTION

The present invention concerns a method of automatically refreshing previously recorded data on a recordable storage medium during playback of the previously recorded data from the recordable storage medium. The method can include the steps of: reading a segment of the previously recorded data from the recordable storage medium; and re-writing at least a portion of the segment of the previously recorded data back onto the recordable storage medium. In one arrangement, the previously recorded data can be refreshed within a data retention period.

In another arrangement, the portion of the segment of the previously recorded data that is re-written to the recordable storage medium can correspond to the segment of the previously recorded data that was read from the recordable storage medium. In addition, the segment of recorded data read from the recordable storage medium and the portion of the segment of the recorded data that is re-written onto the recordable storage medium can be at least one error correction coding (ECC) block. Further, the data previously recorded onto the recordable storage medium produces a maximum bitstream rate during the playback of the previously recorded data and the combined rate of the reading and the re-writing steps is at least twice that of the maximum bitstream rate. The rate of the reading step can also be substantially equal to the rate of the re-writing step.

In another arrangement, the reading step can further include the step of reading the segment of the previously recorded data from the recordable storage medium at an original location, and the re-writing step can further include the step of re-writing at least a portion of the segment of the previously recorded data back onto the recordable storage medium at the original location. Additionally, the portion of the segment of the previously recorded data re-written back onto the recordable storage medium can be re-written at a new location on the recordable storage medium.

The present invention also concerns a method of automatically refreshing data recorded onto a recordable storage medium during playback of the recorded data. The method includes the steps of: creating a file directory for listing when at least one segment of the data was recorded onto the recordable storage medium; reading the segment of the recorded data from the recordable storage medium; and re-writing at least a portion of the segment of the recorded data back onto the recordable storage medium, wherein the reading and re-writing steps are performed at a predetermined time within a data retention period relative to a time stored in the file directory.

In an further arrangement, the recordable storage medium device can perform the reading and re-writing steps when the device is not under user operational control. For example, in a recordable storage medium device which includes multiple disk media the reading and re-writing steps can be performed during periods of device inactivity where the device is ostensibly in an off or standby condition. Furthermore the reading and re-writing steps can be performed in accordance with a predetermined elapsed time period which occurs within a data retention period and is relative to a record creation time stored in a file directory.

In another embodiment, the method can further include the step of selectively examining the segment of the previously recorded data by searching for errors in the previously recorded data in which the re-writing step may be performed only if the level or number of errors in the segment of previously recorded data reaches a predetermined level or number.

In a further alternative arrangement, the invention concerns a method of automatically refreshing data recorded onto a recordable storage medium during playback of the recorded data. The method includes the steps of: reading a segment of the previously recorded data from the recordable storage medium; in an effort to error correct the segment, jumping back to re-read the segment if the number of errors in the segment reaches a first predetermined number; and re-writing at least a portion of the segment of the previously recorded data back onto the recordable storage medium if the number of jump-backs reaches a second predetermined number.

The present invention also concerns a system for automatically refreshing previously recorded data on a recordable storage medium during playback of the previously recorded data from the recordable storage medium. The system includes: a microprocessor; and a controller in which the controller: reads a segment of the previously recorded data from the recordable storage medium; and re-writes at least a portion of the segment of the previously recorded data back onto the recordable storage medium, as instructed by the microprocessor. The system also includes suitable software and circuitry to implement the methods as described above.

### BRIEF DESCRIPTION OF THE DRAWINGS

FIG. 1 is a block diagram of a recordable storage medium device that can automatically refresh data in accordance with the inventive arrangements herein.

FIG. 2 is a flowchart that illustrates an operation of automatically refreshing data in accordance with the inventive arrangements.

FIG. 3 is a flowchart that illustrates an alternative operation of automatically refreshing data in accordance with the inventive arrangements.

FIG. 4 is a flowchart that illustrates another alternative operation of automatically refreshing data in accordance with the inventive arrangements.

### DETAILED DESCRIPTION

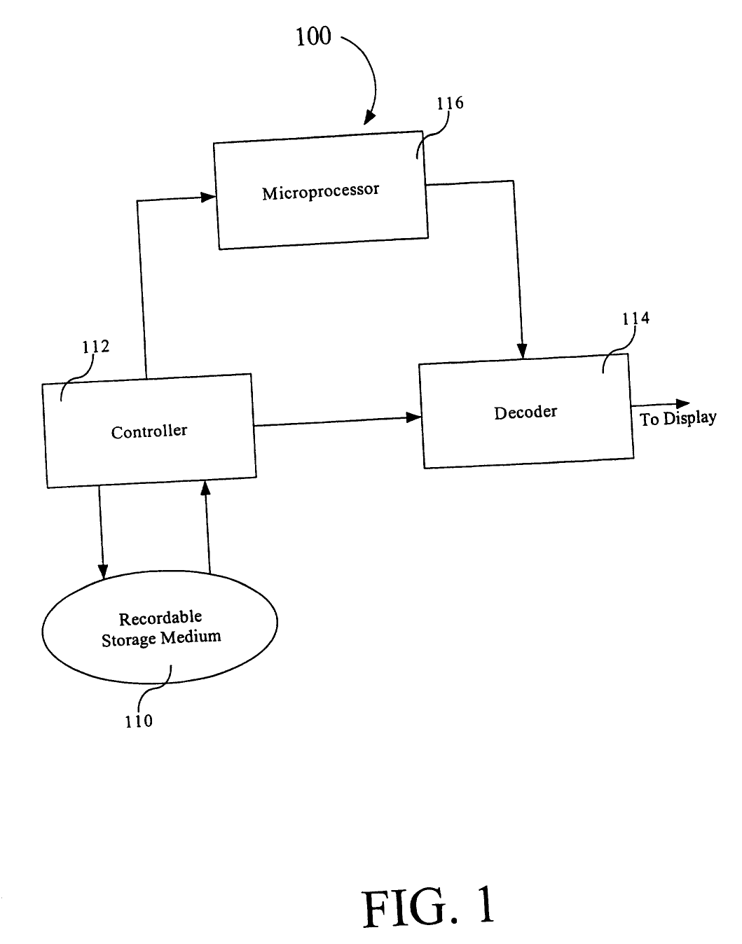

A system 100 implements various advanced operating features in accordance with the inventive arrangements shown in block diagram of FIG. 1. The invention, however, is not limited to the particular system illustrated in FIG. 1, as the invention can be practiced with any other system capable of receiving a digitally encoded signal. In addition, the system 100 is not limited to reading data from or writing data to any particular type of storage medium, as any storage medium capable of storing digitally encoded data can be used with the system 100.

The system 100 can include a controller 112 for reading data from and writing data to a recordable storage medium 110. The system 100 can also have a microprocessor, or microcontroller 116 and a decoder 114. Control and data interfaces can also be provided for permitting the microprocessor 116 to control the operation of the decoder 114 and the controller 112. Suitable software or firmware can be provided in memory for the conventional operations performed by microcontroller 116. Further, program routines can be provided for the microprocessor 116 in accordance with the inventive arrangements. As an example, the microprocessor 116 can create a file directory for listing when at least one segment of the previously recorded data was recorded onto the recordable storage medium. The controller 112 can also contain suitable software and circuitry for selectively examining data read from the recordable storage medium 110.

During play back from a recordable storage medium system 100 can automatically refresh the data previously recorded. Specifically, controller 112 can read a segment of previously recorded data from the recordable storage medium 110 and then re-write at least a portion of the read data segment back onto the recordable storage medium 110, as instructed by microprocessor 116. These reading and re-writing steps, in addition to several other system 100 processes, will be explained in greater detail below.

### Automatically Refreshing Data

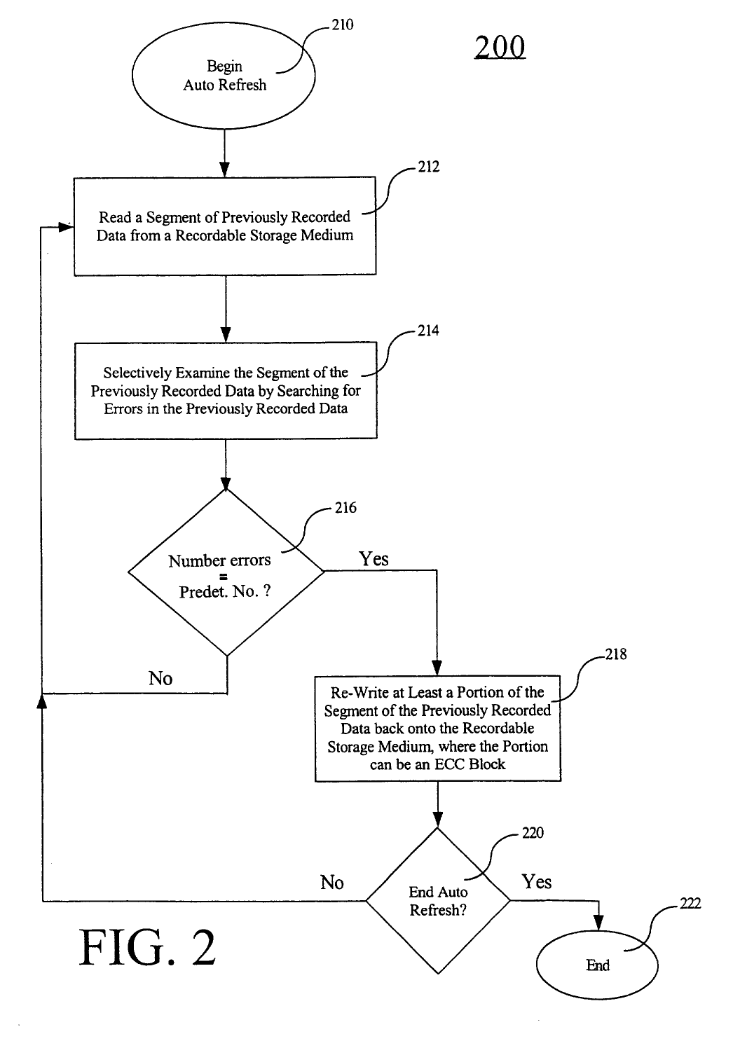

FIG. 2 is an exemplary flowchart 200 showing one way in which previously recorded data can be automatically refreshed. It is understood, however, that the invention is not to be constrained to the sequence illustrated in flowchart 200, as flowchart 200 is merely one example of how previously recorded data can be automatically refreshed. At step 210, the process of automatically refreshing a segment of previously recorded data can begin. For purposes of the invention, the term data can mean numerical data, audio, video or a combination thereof. This refreshing process can be initiated by a user command or a predetermined command based on a temporal parameter, as will be discussed below. In one embodiment, the previously recorded data can be refreshed within a data retention period, which can be predefined. This data retention period is preferably the amount of time before the data recorded on the recordable storage medium has deteriorated to a point where the playback of the data is adversely affected. As an example, if the recordable storage medium is a DVD, then the data retention period can be approximately five years. It is understood, however, that the data retention period is not limited to this or any other particular time frame and can be any other suitable period of time.

At step 212, a segment of the previously recorded data can be read from a recordable storage medium. In one arrangement, the previously recorded data can be read from an original location on the recordable storage medium. In addition, the segment of the previously recorded data can be of a size that includes at least one error correction coding (ECC) block. The invention, however, is not limited in this regard, as any suitable segment of previously recorded data can be read from the recordable storage medium at step 212.

As shown at step 214, the segment of read out data can be selectively examined by searching for errors in the prior recording. Notably, one or more error correction indicators, which may be located in the segment of previously recorded data, can be processed during this step. As an example, multimedia data read from a DVD disc can contain one or more error correction flags, which can be processed to locate errors in the data record. These error correction flags can be inner parity errors, outer parity errors or a combination thereof located within the Reed-Solomon section. It should be noted, however, that these particular error correction indicators are merely examples, as any other suitable error correction indicator may be used to detect and correct errors in the prior recording.

At decision block 216, the number of errors occurring in the transduced record is tested and if the number of errors in the segment has reached a predetermined level or number, then at least a portion of the replay data segment can be re-written onto the recordable storage medium, as shown at step 218. As an example and referring to the above discussion concerning error correction flags, if ten outer parity errors or ten inner parity errors are detected in the read out data segment in which the segment represents one ECC block, or if a combination of outer parity errors and inner parity errors in the ECC block reaches the number ten, then this particular ECC block can be re-written onto the disc. It is understood, however, that the invention is not limited to this particular example, as any other suitable predetermined level of error correction for DVD or any other suitable storage media can be used for purposes of triggering the re-writing process of step 218. In addition and as noted earlier, the invention is not limited to the type of error detection and or correction indicators discussed in this example. Returning to decision block 216, if the level or number of errors in the previously recorded data fails to reach a predetermined number, then decision block 216 tests NO and the auto refresh sequence returns to step 212.

Referring once again to step 218, if at least a portion of the segment of the previously recorded data is to be re-written onto the recordable storage medium, the segment to be re-written can correspond to the segment of the previously recorded data that was read from the recordable storage medium. That is, substantially the same amount of previously recorded data that is read from the recordable storage medium during the reading step 212 can be re-written onto the recordable storage medium during the re-writing step 218 in the same location or a different location of the storage medium. For example, if the segment of previously recorded data that was read from the recordable storage medium represents an ECC block, then this same ECC block of previously recorded data can be re-written onto the recordable storage medium.

In another arrangement, if the segment of previously recorded data is read from an original location as discussed at step 212, then this replay segment can be re-written to the recordable storage medium at this original location. Alternatively, the segment can be re-written at a new location on the recordable storage medium. This new location can be any suitable location on the storage medium capable of receiving the previously recorded data during the re-write step.

Referring to step 212 and step 218, as the previously recorded data from the storage medium is played back, this data can produce a maximum bitstream rate. In one particular arrangement, the combined rate of the reading step and the re-writing step can be at least twice that of the maximum bitstream rate. Thus, if the maximum read out bitstream rate is 10 Mbps, then the combined rate of the reading step and the re-writing step can be at least 20 Mbps. Also, the rate of the reading step and the rate of the re-writing step can be substantially equal. Referring back to the previous example, the rate of the reading step can be at least 10 Mbps, and the rate of the re-writing step can be at least 10 Mbps. It should be noted, however, that the foregoing arrangements are merely examples and that the invention is not limited to any particular algorithm during the refreshing process. Referring to flowchart 200, at decision block 220, if the automatic refreshing process is to continue, then the process sequence returns to step 212 and continues. If not, decision block 220 tests NO and flowchart 200 sequence can end at step 222.

Exemplary flowchart 200 illustrates an arrangement for performing an automatic refreshing process, however, there are several alternatives. For example, the selective examination step (steps 214 and 216) which determine a requirement for re-writing, can be skipped or omitted during an automatic refresh. In this embodiment, steps 210, 212, 218, 220 and 222 remain; however, any segment of previously recorded data on the recordable storage medium can be read and re-written to the recordable storage medium without replay signal or data signal scrutiny or evaluation.

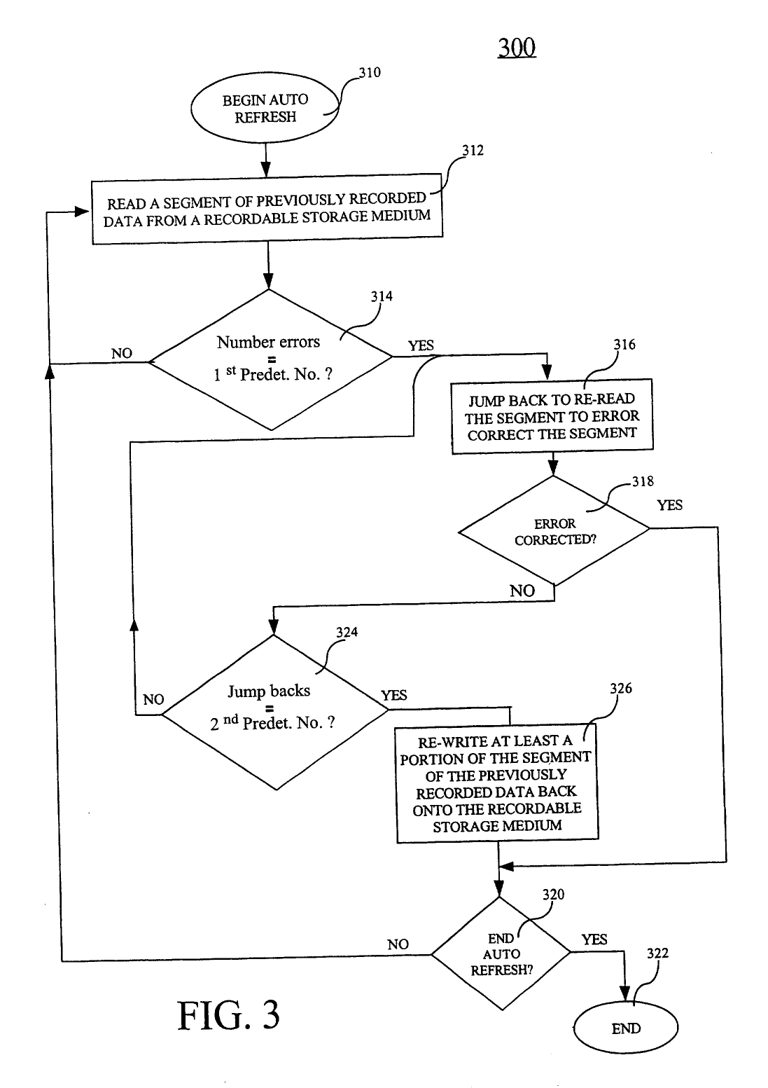

Referring to FIG. 3, flowchart 300 illustrates another arrangement which facilitates an auto refresh process for previously recorded data. At step 310, the auto refresh process is initiated. At step 312, a segment of previously recorded data can be read from a recordable storage medium. Many recordable storage medium devices such as DVD recorders will re-read portions of disk data for the purpose of re-acquiring data to enable successful error correction. Thus, at decision block 314, if the number of errors in the segment has reached a first predetermined level or number, then a jump back instruction is generated causing the transducer part of element 112 to reposition to re-acquire the data segment for the purpose of error correction, as shown at step 316. This first predetermined level of errors can be the predetermined number of errors as discussed in relation to step 216 of flowchart 200; alternatively, this number can be a different value. If the number of errors has not reached the first predetermined level, then the flowchart sequence returns to and continues from step 312.

At decision block 318, a test is performed to determine if error correction has been successfully completed, with a YES resulting in a further decision at block 320 to determine if the auto refresh mode is to end at step 322 or continue by returning to step 312. However, if the segment has not been successfully error corrected, then a No results at block 318 and a jump back or transducer repositioning occurs to reacquire data in order that another error correction step can be performed. The number of times that a transducer jump back has occurred is monitored at decision block 324, where a No results in the sequence returning to step 316 which repositions the transducer.

If the number of jump backs has reached a second predetermined level or number, block 324 tests YES, then at least a portion of the segment of the previously recorded data can be re-written onto the recordable storage medium, as shown at step 326. Termination of the auto refresh mode is tested at decision block 320, where a NO returns the sequence to step 312. A YES at block 320 results in ending the auto refresh mode at step 322. Thus, no matter the value of the first predetermined number of errors, the actual number of jump-backs executed by the transducer to reacquire data can be the criteria that triggers the re-write at step 326. Thus, the re-writing step can be initiated based on a predetermined number of jump-backs executed by attempts to successfully read and error correct a segment of data.

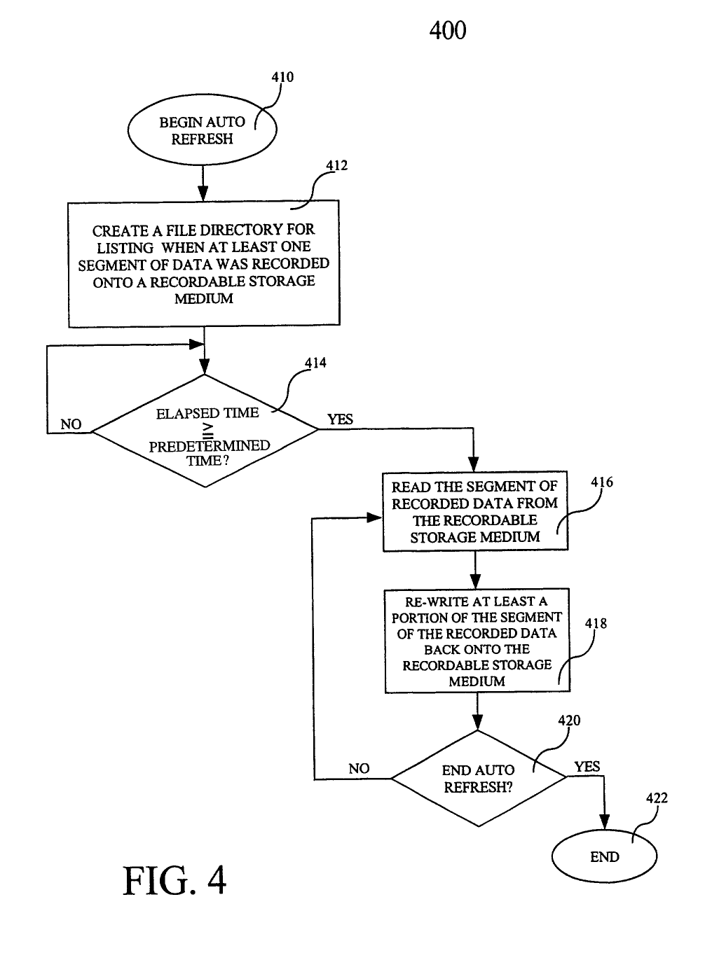

FIG. 4 shows flowchart 400 which depicts a further embodiment of the auto refresh mode where an auto refresh operation is initiated after a predetermined period of time has elapsed since the record was created. The auto refresh mode can begin at step 410. At step 412, a file directory is created which lists a creation date, and or time, or time representative count, when at least one segment of data was recorded on the recordable storage medium. In an alternative arrangement the file directory can list the creation date modified by an offset for example, four or five years. At a predetermined time, but within a disk data retention period of the recordable media, and relative to the creation date and or time stored in the file directory (from the creating step 412) a test is performed at step 414 to determine if a predetermined time period has elapsed since the file (and disk record) were created. Various methods are known which can determine the length of time which has passed since a prescribed date. For example a difference between the current date and the stored creation date can be represented as a number of days. This elapsed day count can be tested for a value equal to or greater than a predetermined number representative of elapsed days. In a similar manner if an offset record creation date is stored in the file directory then a simple comparison can be performed between the current or real time date and the offset file creation date with an auto refresh operation initiated for date differences which fall within a predetermined range of positive and or negative values.

Thus if decision block 414 tests NO a loop is formed which waits for time to pass such that the record creation date or data representative thereof, satisfies the test parameters at block 414. When a YES results the time which has elapsed since record creation is equal to or greater than the predetermined time and a segment of data can be refreshed. At step 416, the segment of data can be read from the recordable storage medium and at step 418, at least a portion of the segment of the read out, previously recorded, data can be re-written onto the recordable storage medium. It can be appreciated that the record creation date file is amended to reflect the execution of an auto refresh sequence. At decision block 420, if the auto refresh process is over, then the sequence of flowchart 400 ends at step 422. If the auto refresh process is to continue, then the process returns to reading step 416 to await the next record which satisfies the elapsed time determination of step 414.

In an further arrangement, the recordable storage medium device can perform the reading and re-writing steps when the device is not in use. For example, in a recordable storage medium device which can include multiple disk media and provides an ability to select therebetween, the reading and re-writing steps can be performed during periods of device inactivity when the device is ostensibly in an off or standby condition. The recordable storage medium device can utilize various parameters to determine a period of inactivity, for example the device controller is aware of the device status, play, record, standby etc. In addition timers within a micro controller system can determine an absence of use, or the occurrence of a prescribed time, for example early morning hours of a particular day of a selected month or months. In this way the device can undertake a periodic audit of the recorded media present within the device and refresh those items of recorded media which satisfy the various rewriting criteria. Furthermore the reading and re-writing steps can be performed in a sequence such as shown in FIG. 4 where a predetermined elapsed time period has a duration less than the data retention period and which is determined relative to the record creation time or date stored in the file directory. As mentioned previously, the execution of an auto refresh sequence also causes the amendment of the record creation date file to reflect the auto refresh date.

It can be appreciated that the various criteria described previously for determining and initiating the rewriting or refresh mode can be implemented singly or in combination in an control arrangement. In such an arrangement any one of the rewrite criteria may cause initiation the inventive data refresh operation.

Although the present invention has been described in conjunction with the embodiments disclosed herein, it should be understood that the foregoing description is intended to illustrate and not limit the scope of the invention as defined by the claims.

What is claimed is:

1. A method of automatically refreshing previously recorded data on a recordable storage medium during playback of the previously recorded data from the recordable storage medium comprising the steps of:
reading a segment of the previously recorded data from the recordable storage medium; and,
re-writing at least a portion of the segment of the previously recorded data back onto the recordable storage medium.

2. The method according to claim 1, wherein the previously recorded data is refreshed within a data retention period.

3. The method according to claim 1, wherein the portion of the segment of the previously recorded data that is re-written to the recordable storage medium corresponds to the segment of the previously recorded data that was read from the recordable storage medium.

4. The method according to claim 3, wherein the segment of recorded data read from the recordable storage medium and the portion of the segment of the recorded data that is re-written onto the recordable storage medium is at least one error correction coding (ECC) block.

5. The method according to claim 1, wherein the data previously recorded onto the recordable storage medium produces a maximum bitstream rate during the playback of the previously recorded data and the combined rate of said reading and said re-writing steps is at least twice that of the maximum bitstream rate.

6. The method according to claim 5, wherein the rate of said reading step is substantially equal to the rate of said re-writing step.

7. The method according to claim 1, wherein said reading step further comprises the step of reading the segment of the previously recorded data from the recordable storage medium at an original location and said re-writing step further comprises the step of re-writing at least a portion of the segment of the previously recorded data back onto the recordable storage medium at the original location.

8. The method according to claim 7, wherein the portion of the segment of the previously recorded data re-written back onto the recordable storage medium is rewritten at a new location on the recordable storage medium.

9. The method according to claim 1, further comprising the step of providing a recordable storage medium device to perform said reading and re-writing steps, wherein said reading and re-writing steps are performed while the recordable storage medium device is not in a user initiated mode.

10. The method according to claim 1, further comprising the step of selectively examining the segment of the previously recorded data by searching for errors in the segment of previously recorded data, wherein said re-writing step is performed only if the level of errors in the segment of previously recorded data reaches a predetermined level.

11. A method of automatically refreshing data recorded on a recordable storage medium during playback of the recorded data comprising the steps of:
creating a file directory for listing when at least one segment of the data was recorded on the recordable storage medium;
reading the segment of the recorded data from the recordable storage medium; and,
when said reading step occurs after a predetermined elapsed time from said creating step re-writing at least a portion of the segment of the recorded data on the recordable storage medium.

12. The method according to claim 11, wherein the predetermined elapsed time occurs within a data retention period.

13. A method of automatically refreshing data recorded onto a recordable storage medium during playback of the recorded data comprising the steps of:
reading a segment of the previously recorded data from the recordable storage medium;
jumping back to re-read the segment if the number of errors in the segment reaches a first predetermined level; and,
re-writing at least a portion of the segment of the previously recorded data back onto the recordable storage medium if the number of jump-backs reaches a second predetermined number.

14. A system for automatically refreshing previously recorded data on a recordable storage medium during playback of the previously recorded data from the recordable storage medium comprising:
a microprocessor; and
a controller, wherein the controller:
reads a segment of the previously recorded data from the recordable storage medium; and,
re-writes at least a portion of the segment of the previously recorded data back onto the recordable storage medium, as instructed by the microprocessor.

15. The system according to claim 14, wherein the previously recorded data is refreshed within a data retention period.

16. The system according to claim 14, wherein the portion of the segment of the previously recorded data that is re-written to the recordable storage medium by the controller corresponds to the segment of the previously recorded data that was read from the recordable storage medium by the controller.

17. The system according to claim 16, wherein the segment of recorded data read from the recordable storage medium by the controller and the portion of the segment of the recorded data that is re-written onto the recordable storage medium by the controller is at least one ECC block.

18. The system according to claim 14, wherein the data previously recorded onto the recordable storage medium by the controller produces a maximum bitstream rate as the controller reads the previously recorded data during playback of the previously recorded data and the combined rate of the reading and the re-writing steps is at least twice that of the maximum bitstream rate.

19. The system according to 18, wherein the rate of the reading step is substantially equal to the rate of the re-writing step.

20. The system according to claim 14, wherein the controller further reads the segment of the previously recorded data from the recordable storage medium at an original location and re-writes at least a portion of the segment of the previously recorded data back onto the recordable storage medium at the original location.

21. The system according to claim 20, wherein the portion of the segment of the previously recorded data re-written back onto the recordable storage medium by the controller is re-written at a new location on the recordable storage medium by the controller.

22. The system according to claim 14, wherein the controller and the microprocessor are contained within a recordable storage medium device and the controller performs the reading and re-writing steps while the recordable storage medium device is not in a user initiated mode.

23. The system according to claim 14, wherein the controller selectively examines the segment of the previously recorded data by searching for errors in the segment of previously recorded data, wherein the microprocessor instructs the controller to perform the re-writing step only if the level of errors in the segment of previously recorded data reaches a predetermined level.

24. A system for automatically refreshing data recorded onto a recordable storage medium during playback of the recorded data comprising:
a microprocessor for creating a file directory listing a creation date of at least one segment of the data recorded onto the recordable storage medium;
a controller, wherein the controller:
reads the segment of the recorded data from the recordable storage medium; and
re-writes at least a portion of the segment of the recorded data onto the recordable storage medium, responsive to the microprocessor, wherein said reading and re-writing steps occur at a predetermined time within a data retention period relative to the creation date stored in the file directory.

25. A system for automatically refreshing data recorded onto a recordable storage medium during playback of the recorded data, comprising:
a microprocessor; and
a controller, wherein the controller:
reads a segment of the previously recorded data from the recordable storage medium; and responsive to a number of errors in the segment reaching a first predetermined number causes a jump back to re-read the segment; and,
responsive to a number of jump-backs equaling a second predetermined number the microprocessor initiates a re-write of at least a portion of the segment of the previously recorded data onto the recordable storage medium.

26. A method of automatically refreshing data recorded on a plurality of recordable storage media comprising the steps of:
selecting one of said recordable storage media;
reading a file directory with information representative of a record creation date for at least one segment of the data recorded on said selected recordable storage medium;
re-writing at least a portion of the segment of the recorded data on the recordable storage medium if a predetermined time has elapsed from said record creation date represented by said information within said file directory; and,
repeating said selecting reading and rewriting steps for remaining ones of said plurality of recordable storage media.

27. A method of claim 26, comprising a further step of:
repeating said selecting reading rewriting and repeating steps periodically.
